(19) United States
(12) Patent Application Publication
(10) Pub. No.: US 2008/0120881 A1
(43) Pub. Date: May 29, 2008

(54) TYING OR CARRYING DEVICE, ROLL OR SHEET OF DEVICES, AND METHOD OF USING SAME

(75) Inventors: Darren Rhinehart, Atlanta, GA (US); Gregory Lombardi, Cambridge, MA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Darren Rhinehart, Atlanta, GA (US)

(21) Appl. No.: 11/464,978

(22) Filed: Aug. 16, 2006

(51) Int. Cl. B65D 65/28; G09F 3/14; A41D 27/22

(52) U.S. Cl. 40/665; 428/43; 223/87

(57) ABSTRACT

The invention includes a tying or carrying device comprising a flexible elongate member defining generally flat top and bottom surfaces and defining at least two apertures spaced apart and extending longitudinally along the flexible elongate member and between the top and bottom surfaces. The device may be used to carry a plurality of objects, such as garment hangers. The invention includes a roll or sheet comprising a flexible foamed polymer, wherein the roll or sheet is cut to form two or more of the flexible elongate members. The invention further includes a method for carrying a plurality of items comprising the steps of providing a device comprising an elongated member, placing a portion of each item between the ends of the elongated member, inserting the an end of the elongated member through an aperture, pulling, and placing a hand or protrusion through an aperture or grasping an end.

### BACKGROUND OF THE INVENTION

This invention relates to a tying or carrying device for a plurality of articles with a loop or hook member, such as garment hangers.

In the garment cleaning industry, garments are typically hung on individual wire or wire-topped garment hangers by the garment cleaner. As is well known, these individual garment hangers are typically grouped by customer and the individual hangers belonging to a single customer are tied together below the hook portion of the garment hanger with either a coated piece of wire commonly referred to as a “twist-tie” or a piece of tape. The garment cleaner or customer must then carry the garments in his hand using the hook portions of each of the garment hangers.

Carrying the garments by the hook portion of a hanger is often uncomfortable because the weight of the garment on the wire hangers can cause the rigid wire hangers to dig into the carrier's hand, impairing circulation and causing marks. The pointed end of the wire hanger can also cause discomfort. This discomfort is exacerbated when several garments are carried at once and when the garments are carried for a long period of time. Customers carrying garments on hangers often must switch hands periodically to alleviate the discomfort, and this switching causes delay in transporting the garments from one place to another.

Carrying garment hangers in one's hand by the hook portion of a hanger also makes it difficult to transfer the hangers from one place to another, such as from a person's hand to a hanging pole in the garment cleaning establishment or to a hanging apparatus in a vehicle. This is because several individual hangers must be moved with each transfer. If a single hanger is not included in the transfer, the garment on that hanger could be dropped and soiled, which defeats the purpose of cleaning the garment in the first place.

Furthermore, using hangers and a twist tie, the types of apparatuses that may be used to hang garments on a hanger must be at least as long as the width of the tied garment hangers. As a result, passenger seat hooks in many sedans and other vehicles cannot be used to transport more than one or two cleaned garments. Similarly, the number of garments that may be carried in a single person's hand is limited to the width of that person's hand, regardless of the strength of the person.

Because of these problems with the typical manner of grouping and carrying multiple garment hangers, a device or method for comfortably tying and carrying multiple garment hangers is desirable. A device or method for tying or carrying multiple garment hangers such that the individual hangers cannot slip when transferred from one location to another is also desirable. A device or method for tying or carrying multiple garment hangers or other items which also reduces the required width of the carrying means is also further desirable.

### BRIEF SUMMARY OF THE INVENTION

The present invention seeks to provide a method or device for tying or carrying multiple items in a comfortable and convenient manner, which also reduces the required width of the carrying means and minimizes dropping of the items. The foregoing objects are accomplished with a device or method of carrying using an elongate member with at least two apertures spaced apart longitudinally.

One embodiment of the invention is a tying or carrying device comprising a flexible elongate member with generally flat top and bottom surfaces. The elongate member defines at least two spaced apart apertures each extending between the top and bottom surfaces. The apertures preferably extend longitudinally along the flexible elongate member. The elongated apertures preferably comprise slits that are cut or punched into the elongated member. The elongated member preferably comprises a soft and flexible material, such as a flexible foamed polymer material. In one embodiment, the elongated member is reinforced on at least one end of at least one aperture. In another embodiment, the elongated member is reinforced throughout. In a preferred embodiment, the width of the middle section of the elongated member is greater than the width of the first end and the width of the second end.

Another embodiment of the invention is a roll or sheet comprising a flexible foamed polymer, wherein the roll or sheet is cut to form two or more flexible elongate members. Optionally, the roll or sheet is perforated such that flexible elongate members may be separated by pulling on at least one of them. Each flexible elongate member has generally flat top and bottom surfaces and two apertures spaced apart and extending longitudinally along the flexible elongate member and between the top and bottom surfaces. Each elongate member also has a middle section located between the two apertures.

Yet another embodiment of the invention is a method for tying a plurality of items each with a hook or loop member, such as garment hangers. The method comprises providing a device as previously described, placing a portion of each item to be tied, preferably the hook or loop portion, between the first end and second end of the elongated member, and inserting the first end of the elongated member through the second aperture. The items may then be carried by placing a hand or other carrying object through the first aperture, using it as a handle, or by grasping the first end of the elongated member.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a top plan view of one embodiment of the invention;

FIG. 2 is a pictorial view of the embodiment depicted in FIG. 1;

FIG. 3 is a top plan view of another embodiment of the invention;

FIG. 4 is a cross-sectional view of the embodiment depicted in FIGS. 1 and 2;

FIG. 5 is a cross-sectional view of another embodiment of the invention;

FIG. 6 is a cross-sectional view of another embodiment of the invention;

FIG. 7 is a pictorial view of an embodiment of the invention used with garment hangers;

FIG. 8 is a pictorial view of an embodiment of the invention used with garment hangers;

FIG. 9 is a plan view of a sheet of devices in accordance with the invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

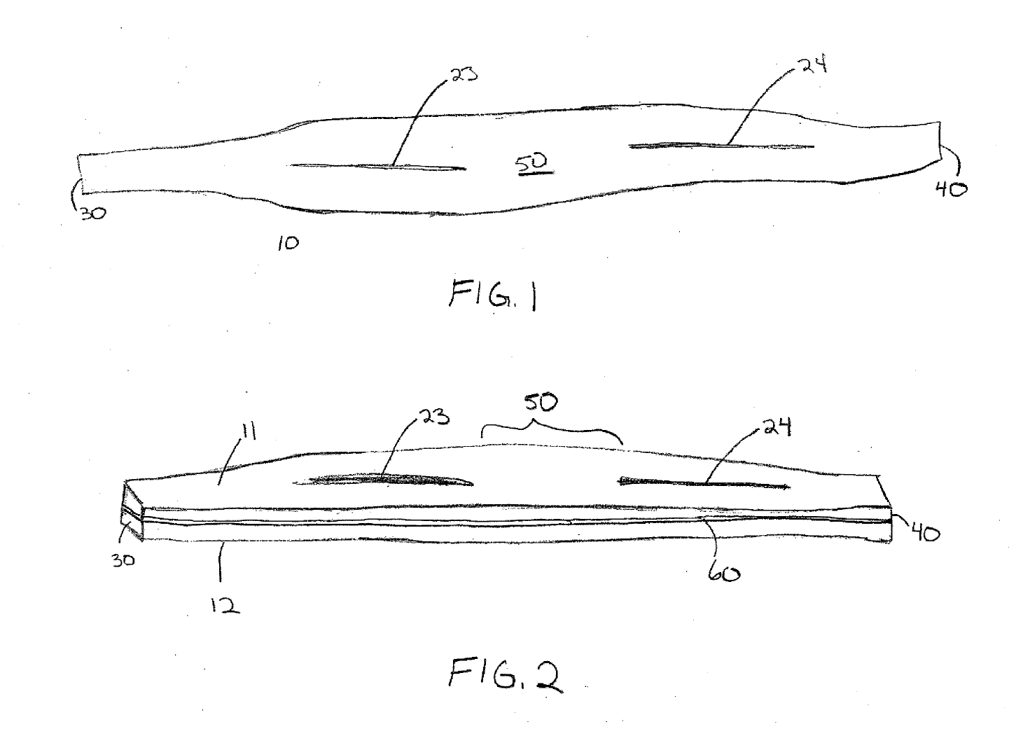

Referring more specifically to the drawings, for purposes of illustration but not of limitation, there is shown in FIG. 1 and FIG. 2 a tying device comprising an elongate member 10 with a first end 30, a second end 40, a first surface 11, and a second surface 12. Located longitudinally, or lengthwise, along the member and optionally along a longitudinal axis are two spaced-apart apertures in the form of slits, 23 and 24. Separating the two apertures is a middle member section 50.

The two apertures may be of the same or different size. While a slit will suffice, material may be removed to form an opening having an area. Openings having a wide variety of shapes can be employed.

The elongate member 10 may be comprised of a flexible material capable of providing friction when folded upon or contacting itself. Preferably, the elongate member is comprised of a soft, flexible material, such as a foamed polymer, including foamed polyolefins. Examples of suitable foamed polyolefins include but are not limited to polyvinyl chlorides (PVCs), low-density polyethylene (LDPE), high-density polyethylene (HDPE), ethylene vinyl acetate (EVA) and copolymers thereof. Suitable foamed polymers may include open cell or closed cell structures, preferably closed cell structures. Alternately, the elongate member may be composed of a soft solid material, i.e. a material that does not include air voids, such as a flexible solid polymer. Preferred soft solid materials include thermoplastic elastomers (TPEs).

As shown in FIG. 2, in one embodiment at least one reinforcing member in the form of a reinforcing material 60 extends along the entire length of the elongate member. The reinforcing material 60 may be located on or along the first surface 11 or on or along the second surface 12; for example, the reinforcing material may be laminated on the first surface, the second surface, or reinforcing materials may be laminated on both. The reinforcing material may also be located within the material forming the elongate member between the first surface and the second surface; for example, embedded within the material or sandwiched between materials. Multiple reinforcing materials may also be present, such as a first reinforcing material located along the first surface 11 and a second reinforcing material located along the second surface 12, or multiple reinforcing materials located between the first surface and the second surface.

Reinforcing materials may be present on or within the material forming the elongate member to form a composite material. Examples of suitable reinforcing materials include but are not limited to polymer threads, polymer webs, and polymer sheets, including polyester thread or webs and nylon thread or webs, and woven or non-woven webs, and other fabric webs or meshes. Other suitable reinforcing materials include materials formed from coatings such as enamels or polymer films. Reinforced foamed polymers, such as those used to produce exercise and yoga mats, may be used to manufacture the device of the present invention. In one preferred embodiment, the elongate member is comprised of a closed-cell foamed PVC polymer with a fabric mesh reinforcing material embedded within the foamed polymer.

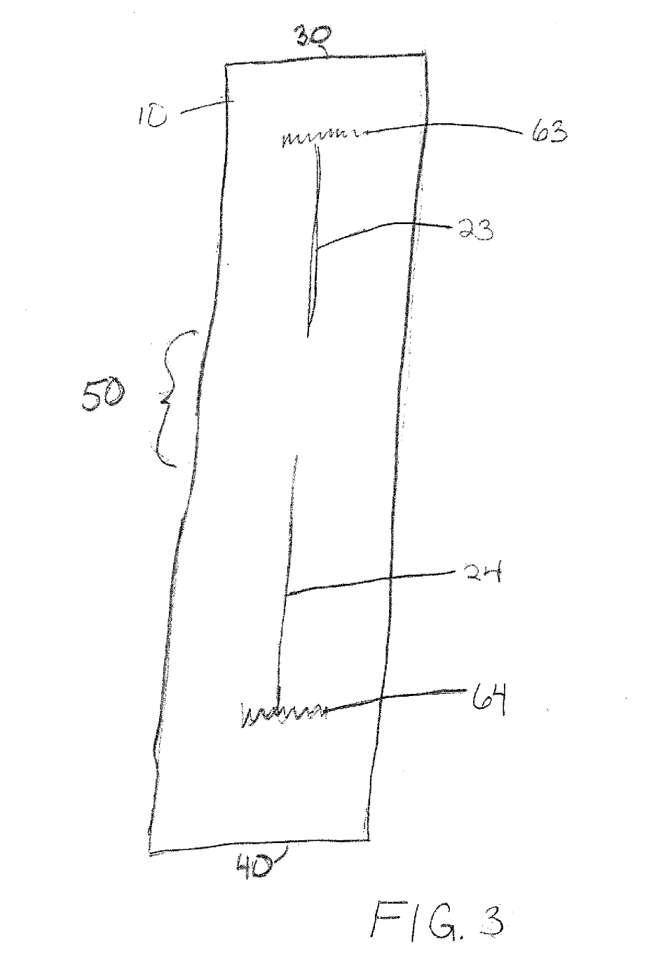

As shown in FIG. 3, in another embodiment, two reinforcing members 63 and 64 are located at the end of the first aperture 23 closest to the first end 30 and along the second aperture 24 closest to the second end 40, respectively. As shown in FIG. 3, the two reinforcing members 63, 64 are located along the first surface, though they may extend beyond the first surface into or through the material forming the elongated member. Alternatively, the two reinforcing members may be located within or between the first surface and the second surface. The reinforcing members 63, 64 may, for example, be in the form of a reinforcing coating applied to the surface of the elongate member, a seam sewn into the elongate member, or a rigid or semi-rigid material applied to the elongate member.

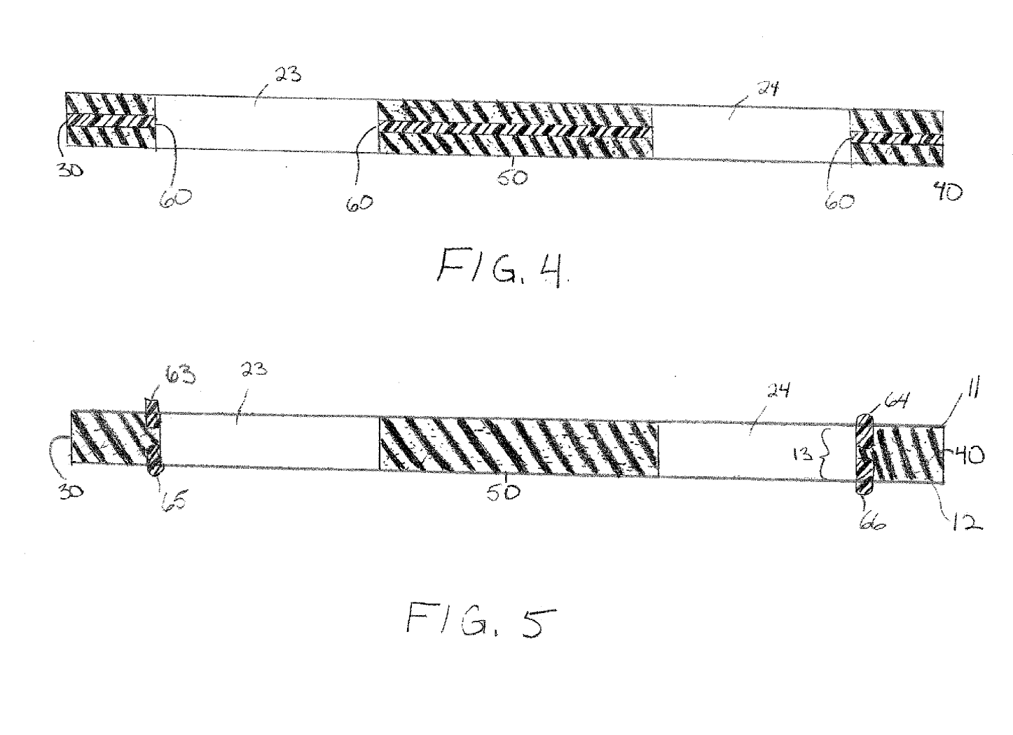

As mentioned above and with respect to FIG. 2 and also shown in the cross sectional view of FIG. 4, in one embodiment the reinforcing member may be embedded within the elongate member and extend the length of the material.

As mentioned above with respect to FIG. 3 and also shown in FIG. 5, multiple reinforcing members 63, 64, 65, 66 may be located at discrete positions along the first surface 11 and/or the second surface 12 and optionally extending within the material to the interior part 13 between the first surface 11 and the second surface 12. As shown in the embodiment depicted in FIG. 5, there are four reinforcing members along the elongate member. The first reinforcing member 63 is located along the first surface 12 and extends into the interior part 13. The second reinforcing member 64 is also located along

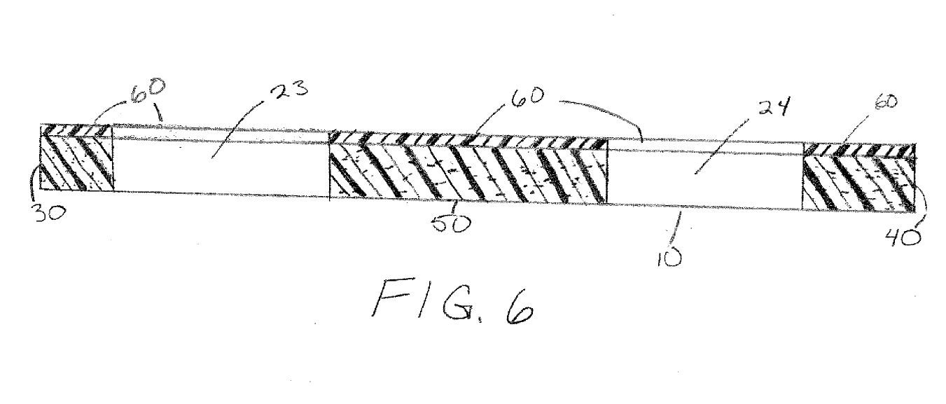

A single reinforced material 60 may also be laminated on the first surface 11 and extending the length of the elongated member 10, as shown in FIG. 6. In another embodiment, two reinforced material members are present with one along the first surface and one along the second surface. In yet another embodiment, a reinforced material is located along the second surface only.

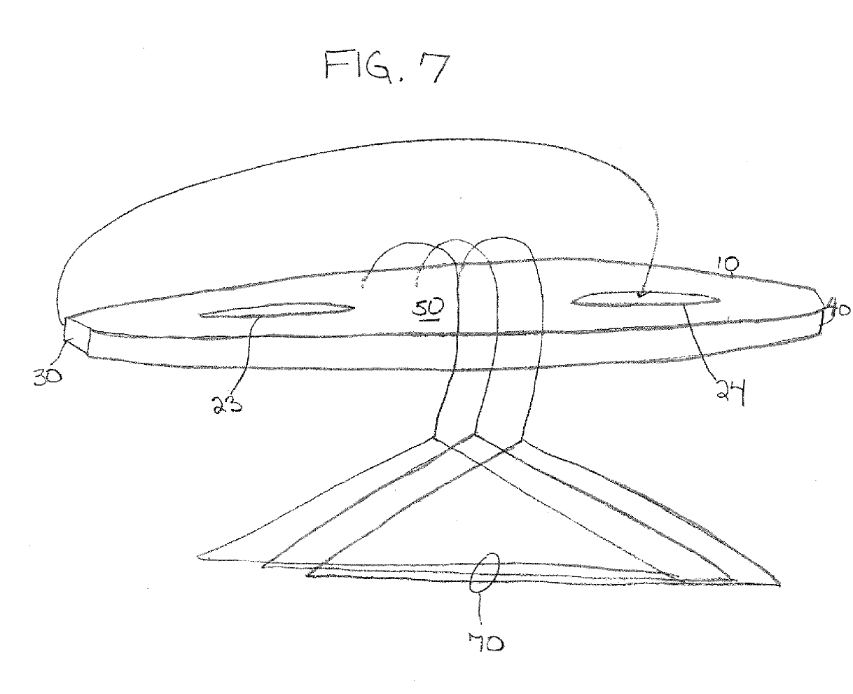

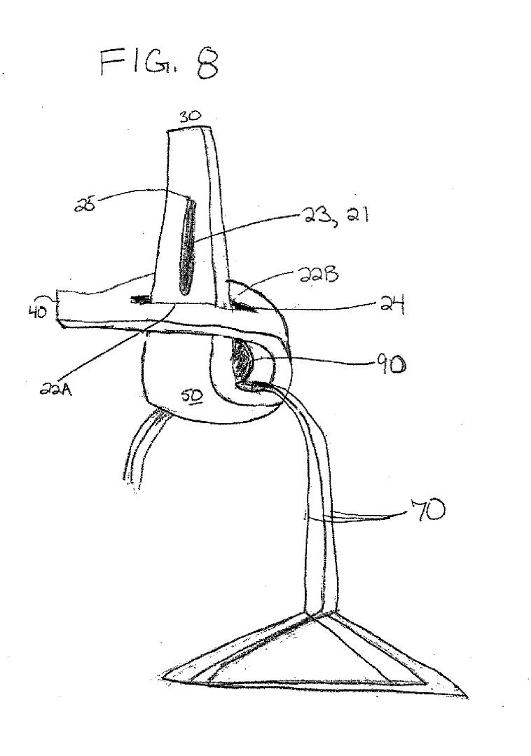

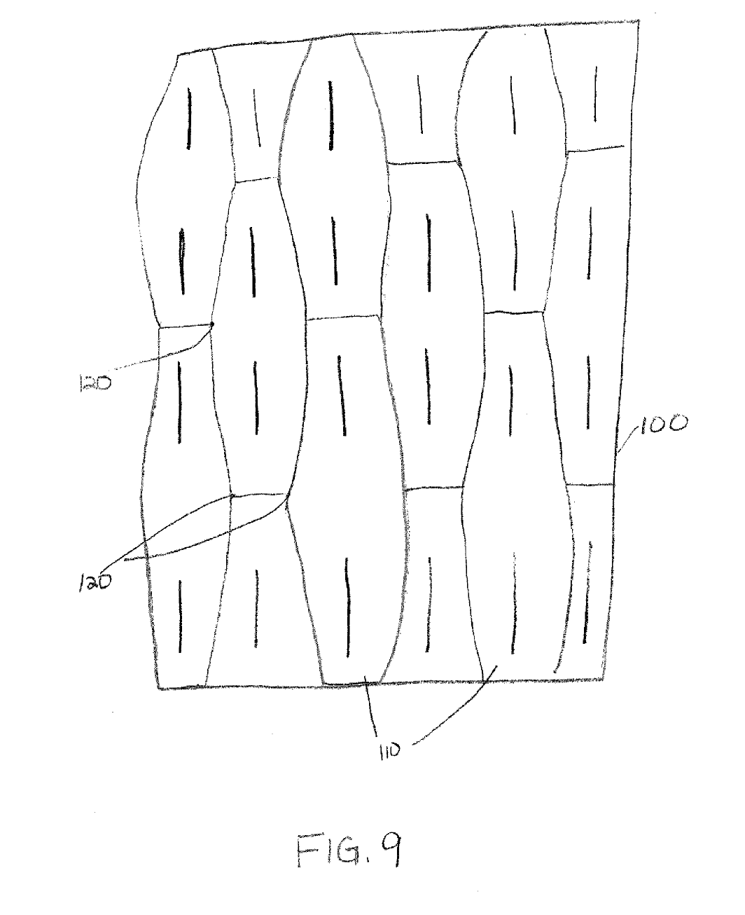

As shown in FIGS. 7 and 8, the plurality of objects 70 to be tied and/or carried, such as garment hangers, may be placed on or near the middle member section 50. One manner in which this may be done is by placing the elongate member on a surface and placing the plurality of objects 70 on top near the middle member section 50. Alternatively, the elongate member 10 may be threaded underneath a hook or loop portions of the plurality of objects 70. When threading the elongate member, it is not necessary to position each of the objects near the middle member section, as long as each of the objects is located between the first end 30 and the second end 40 of the elongate member 10. Once all of the objects to be tied or carried are in place, the first end 30 may be inserted through the second aperture 24. Friction from the elongate member holds the garments in place atop the middle member section 50, which forms a holding loop 90. The plurality of objects may then be picked up by grasping the first end 30, or by placing a hand or other carrying device through the first aperture 23, which forms a handle 21 by opening the first aperture. The handle 21 may also be placed on a protrusion, such as a hook located in a vehicle.

When the first aperture 23 is used as a handle, the interior first aperture end surface 25 bears the full weight of all of the objects. This weight will exert a separating force tending to cause the first aperture to tear in the longitudinal direction, particularly when the first aperture is a slit cut into the elongated member. However, the first aperture of the present invention resists tearing in the longitudinal direction because of the reinforcing material 60 and/or the reinforcing members 63, 64, 65, 66. Alternatively, the material comprising the elongated member is selected such that the material can bear the weight of the plurality of objects without tearing. Preferably, the first aperture is reinforced such that it can bear more than 20 pounds, more preferably more than 35 pounds, most preferably more than 50 pounds weight.

Preferably, the first aperture 23 is long enough and flexible enough such that when the aperture is opened, a hand may be comfortably inserted transverse to the length of the direction. When the aperture is in the form of a slit, the elongate member may be pulled or stretched in the transverse direction so that the hand may be inserted. Preferably, the slit is long enough to accommodate at least three fingers of a person's hand and at least about 2 inches long. Preferably, the first aperture 23 is about 3 to about 5 inches long, more preferably about 3 to about 4 inches long.

The first aperture 23 and second aperture 24 may be of the same or different lengths. In one embodiment, the first aperture 23 and second aperture 24 are the same or similar lengths such that the device is essentially reversible; that is, either aperture may be used as a first aperture or a second aperture. The second aperture 24 should be long enough such that the widest portion of the elongate member may fit through the second aperture. Preferably, the first end 30 of the elongate member is narrower in width than the middle member section 50.

The length and width of the middle member section 50 can vary based on the number and size of objects to be tied or carried. Preferably, the width of the middle member section 50 is small enough such that the hook or loop portions of the plurality of objects 70 fit on the middle member section but large enough to provide stable support to the plurality of objects 70 when the elongate member 10 is tied. Preferably, the middle member section 50 is from about ½ inch to about 2 inches wide, more preferably about 1 to 1½ inches wide. The middle member section 50 may be of uniform width, or the width may vary along the length of the middle member section. The length of the middle member section 50 may vary based on the number and width of the objects to be carried; for use with garment hangers, the thickness of the material used to form the hanger hook is a factor, because plastic hangers are much thicker than standard wire hangers. Preferably, the middle member section 50 is from about 1 inch to about 5 inches long, though longer middle sections may be used. More preferably, when carrying a small number of garment hangers, the middle member section is about 2 to about 4 inches long.

The overall length of the elongate member can likewise vary based on the number and type of objects to be carried, the width of the elongate member, and the desired handle size. Preferably, the elongate member has an overall length of about 10 to about 16 inches.

The ratio of the overall length of the elongate member 10 to the width of the middle member section 50 can vary and is generally a ratio such that the elongate member may be folded or tied as explained herein and in FIG. 5. Preferably, the ratio of the overall length of the elongate member to the width of the middle member section at its widest is from about 5:1 to about 20:1, more preferably about 8:1 to about 15:1, most preferably about 11:1 to about 13:1.

While reference is generally made herein to use of the device by the garment cleaning (e.g. dry cleaning) establishment, the device described herein may also be used to tie or hold a plurality of hangers or garments on hangers by, for example, clothing repair facilities, garment manufacturers, distributors, and retail establishments, and the like. Similarly, while reference is generally made herein to use of the device to tie or carry one or more garment hangers, the device may also be used to tie or carry other objects with a hook, loop, or hole member including, for example, plastic grocery bags or tools.

The first surface 11 and second surface 12, as well as the interior surfaces of the second aperture, 22A and 22B, provide friction such that when the surfaces are contacted during tying or handling, the plurality of objects are held in place without excessive slipping or movement of the elongate member in the second aperture. Preferably, the material comprising the elongate member has coefficient of friction high enough to prevent excessive slipping of the plurality of objects. The first surface 11, second surface 12, and surfaces of the second aperture 22A, 22B may be smooth surfaces, or they may include small bumps or protrusions to reduce movement of the elongate member when folded or tied.

The thickness of the elongate member 10 may vary. Because the first elongate member 23 may be used as a handle, the elongate member preferably is thick enough such that the weight of the device and objects held in place by the device is comfortably distributed on a carrier's hand. However, the elongate member is also preferably thin enough such that the handle 21 may be placed on a small hook or protrusion to hold the device. Furthermore, the elongate member should be also thin enough such that the first end 30 may be easily inserted through the second aperture 24. The elongate member is preferably about ⅛ inch to about ½ inch thick, more preferably about ¼ inch thick.

In one embodiment, the device of the present invention may be manufactured from a sheet or continuous flat roll of material, such as a flat roll of reinforced flexible foamed polymer. Because of the simple lines in the design of the embodiments of present invention, the device may be cut from a flat roll or punched out with a die. When the apertures are in the form of slits, multiple devices may be formed from a single sheet or roll of material with little wasted material. In one embodiment of the invention as shown in FIG. 9, a sheet 100 comprises multiple elongated members 10 arranged on the sheet of material. The cuts forming the elongated member 110 may be full cuts, may be perforations, or may be cuts with breaks at locations to hold the sheet together, such as at the intersection of multiple elongated members 120. The sheet 100 or roll may be provided to an individual, such as a dry cleaner, such that individual devices may be torn off as needed and distributed to individual customers.

Because the device of the present invention may be mass produced without a need for individually casting or sewing each device, and because the preferred foamed polymer materials are readily available and used for making other items, the device of the present invention may be inexpensively manufactured. The device of the present invention may be used in place of twist ties by a garment cleaner to secure multiple hanging items for a single customer. In this scenario, the device serves the function of both securing multiple items together and providing a handle for carrying the items. The device may also be used in addition to twist ties to provide an additional level of securing multiple objects and to provide a convenient, comfortable carrying handle. Because of its low manufacturing cost, the device may be a consumable item distributed by the garment cleaner. However, due to the reinforced material in the elongated member, the device is durable and may be reused by the consumer or by the garment cleaner for multiple uses.

The device and method of the present invention make it possible for an individual to comfortably tie and carry multiple garment hangers. Furthermore, the device and method of the present invention secure individual hangers so that they cannot slip when transferred from one location to another. Because the device and method secures all of the hangers in the middle member section but forms a handle that may be used for hanging or carrying, the present invention also reduces the required width of a carrying means such that narrow hooks or protrusions, such as those commonly found above the windows in the back seat of passenger vehicles, may be used to carry multiple hanging garments so that the garments do not fall or wrinkle.

The invention has been described with reference to various specific and preferred embodiments and techniques. However, it should be understood that many variations and modifications may be made while remaining within the spirit and scope of the invention.

That which is claimed:

1. A tying or carrying device comprising a flexible elongate member defining generally flat top and bottom surfaces and defining at least two apertures spaced apart and extending longitudinally along the flexible elongate member and between the top and bottom surfaces.

2. The device as claimed in claim 1, wherein the flexible elongate member is reinforced.

3. The device as claimed in claim 1, wherein the flexible elongate member comprises a foamed polymer material.

4. The device as claimed in claim 3, wherein the foamed polymer material is selected from the group consisting of foamed polyvinyl chlorides, low-density polyethylene, high-density polyethylene, ethylene vinyl acetate, and copolymers thereof.

5. The device as claimed in claim 3, the member comprising a foamed polymer with a reinforcing layer.

6. The device as claimed in claim 5, wherein the reinforcing layer comprises at least one material selected from the group consisting of polymer thread and polymer web.

7. The device as claimed in claim 5, wherein the reinforcing layer comprises polyester thread or nylon thread.

8. The device as claimed in claim 1, wherein the at least two apertures include at least one aperture elongated longitudinally in relation to the flexible elongate member.

9. The device as claimed in claim 1, wherein the at least two apertures comprise slits extending longitudinally along the flexible elongate member.

10. The device as claimed in claim 1, further comprising at least one reinforcing member adjacent to one of the at least two apertures.

11. The device as claimed in claim 1, wherein the flexible elongate member comprises a first end, a second end opposite the first end, and a middle section between the first end and the second end and between the at least two apertures, wherein the width of the middle section is greater than the width of the first end and the width of the second end.

12. The device as claimed in claim 1, wherein the flexible elongate member comprises a soft foamed polymer.

13. The device as claimed in claim 1, wherein the flexible elongate member is from 10 to 16 inches long, from ¼ inch to 2 inches wide, and from ⅛ inch to ¼ inch thick.

14. The device as claimed in claim 1, wherein the ratio of the length of the flexible elongate member to the width of the flexible elongate member at its widest point is from about 5:1 to about 20:1

15. The device as claimed in claim 1, wherein at least one of the at least two apertures is at least about 2 inches long.

16. A roll or sheet comprising a flexible foamed polymer, wherein the roll or sheet is cut to form two or more flexible elongate members each defining generally flat top and bottom surfaces and defining two apertures spaced apart and extending longitudinally along the flexible elongate member and between the top and bottom surfaces and a middle section located between the two apertures.

17. The roll or sheet as claimed in claim 1, wherein the roll or sheet is cut such that it is perforated between two or more flexible elongate members such that the two or more flexible elongate members may be separated by pulling on at least one of the members.

18. The roll or sheet as claimed in claim 1, wherein the flexible foamed polymer is reinforced.

19. A method for carrying a plurality of items wherein said items each have a hook or loop member, the method comprising the steps of:
providing a device comprising an elongate reinforced generally flat member comprising a a first end, a second end opposite the first end, a first aperture located along the longitudinal axis of the member, a second aperture also located along the longitudinal axis of the elongated member and a middle section between the first end and the second end and between first aperture and second aperture,
placing a portion of each item between the first end and the second end of the elongated member,
inserting the first end through the second aperture to form a loop,
pulling the first end to tighten the loop around the portions of the items; and
placing a hand or carrying protrusion through the first aperture.
